(19) United States
(12) Patent Application Publication
(10) Pub. No.: US 2025/0220062 A1
(43) Pub. Date: Jul. 3, 2025

(54) SYSTEM AND METHOD FOR CONTROLLING STREAMS IN MANY-TO-MANY STREAMING SERVICES

(71) Applicant: SEOUL NATIONAL UNIVERSITY R&DB FOUNDATION, Seoul (KR)

(72) Inventors: Kyunghan LEE, Seoul (KR); Jong Yun LEE, Seoul (KR)

(21) Appl. No.: 18/982,476

(22) Filed: Dec. 16, 2024

Related U.S. Application Data
(63) Continuation of application No. PCT/KR2024/012596, filed on Aug. 23, 2024.

(30) Foreign Application Priority Data
Dec. 29, 2023 (KR) 10-2023-0196841
Feb. 29, 2024 (KR) 10-2024-0029595

(51) Int. Cl. H04L 65/613

(52) U.S. Cl. CPC H04L 65/613

(57) ABSTRACT

A stream control system for many-to-many streaming services includes a plurality of client devices receiving a bitrate map including identification information for at least one transmitting client device from a media server, grade information of a transmission stream transmitted by each transmitting client device, and bitrate information for each grade of the transmission stream, generating a selection table including a plurality of combinations of reception streams and selecting a combination of reception streams based on a frame delay time, and a media server receiving encoded media from at least one transmitting client device and transmitting the media to at least one receiving client device, wherein the client device determines the frame delay time based on transmission start time information inserted into a media frame received from the transmitting client device and an arrival time of the media frame.

### CROSS-REFERENCE TO RELATED APPLICATION

This application is a continuation of International Application No. PCT/KR2024/012596 filed on Aug. 23, 2024, which claims priority to Korean Patent Application No. 10-2024-0029595, filed on Feb. 29, 2024, and No. 10-2023-0196841, filed on Dec. 29, 2023, in the Korean Intellectual Property Office, the entire contents of which are herein incorporated by reference.

### BACKGROUND

The present disclosure relates to a stream control system and method for controlling a reception stream and a transmission stream in a many-to-many streaming service.

Recently, as multimedia communication services have become more popular, multimedia technology is developing based on video communication that allows face-to-face conversations with people who are geographically distant.

Among multimedia technologies, large-scale video conferencing systems allow multiple people to exchange conference information, such as voice and video, through a network. The video conferencing system is applied to the media server and client of the selective forwarding unit (SFU), which is a streaming structure. In the SFU architecture, each client transmits streams of video of the client encoded at multiple bitrates to a media server, and the media server delivers the streams that match the network conditions of each client among the received video streams to other clients.

In this case, because in the SFU structure, the operations of determining the bitrate setting value and selecting the stream to be transmitted have a significant impact on the service quality (delay time and video quality) experienced by users, technologies have been developed to improve these problems.

The technologies configured a system for the purpose by using one of the following methods: a method for achieving low-latency performance by setting a low fixed bitrate, and a control method for optimizing bitrate determination and stream selection by having the media server periodically collect network bandwidth information of all users.

However, these methods have limitations in achieving both low latency and high quality performance in large-scale video conferencing services. The method of using a fixed bitrate achieves stable low-latency performance, but has the limitation of inevitably degrading video quality. The method of optimizing bitrate determination and stream selection achieves low-latency, high-quality performance when the number of users is small, but when the number of users increases, the optimizing method has limitations in that the optimizing method may not quickly change the bitrate and stream selection to respond to increased latency of each user due to the time it takes to solve the optimization problem known as the Knapsack problem.

Therefore, technology to solve such problems is required.

Related art includes Korean Patent No. 10-2537858 (Title of the Invention: A METHOD AND BITRATE CONTROLLER FOR CONTROLLING OUTPUT BITRATE OF A VIDEO ENCODER)

### SUMMARY

In order to solve the above-mentioned problem as a technical problem, the present disclosure provides a stream control system and method in which a receiving client device selects a combination of reception streams including transmission stream grade information of each transmitting client device based on frame delay time, and a media server adjusts a bitrate of a transmission stream grade of a transmitting client device based on the combination of reception streams selected by the receiving client device.

However, the technical tasks that an embodiment seeks to accomplish are not limited to the technical tasks described above, and other technical tasks may exist.

As a technical means for solving the above-described technical problem, a stream control system for many-to-many streaming services, according to an aspect of the present disclosure including: a plurality of client devices receiving a bitrate map including identification information for at least one transmitting client device from a media server, grade information of a transmission stream transmitted by each transmitting client device, and bitrate information for each grade of the transmission stream, generating a selection table including a plurality of combinations of reception streams including a grade of a transmission stream to be received from each transmitting client device based on the bitrate map and a summed bitrate that is the sum of the bitrates of each transmission stream grade, and selecting a combination of reception streams based on a frame delay time; and a media server receiving encoded media from at least one transmitting client device and transmitting the media to at least one receiving client device, wherein the client device determines the frame delay time based on transmission start time information inserted into a media frame received from the transmitting client device and an arrival time of the media frame.

In addition, a method of controlling streams in a many-to-many streaming service, according to an aspect of the present disclosure, including: an operation (a) in which a receiving client device receives, from a media server, a bitrate map including identification information for each of at least one transmitting client device, grade information of a transmission stream transmitted by each transmitting client device, and bitrate information for each transmission stream grade; an operation (b) in which the receiving client device generates a selection table composed a plurality of combinations of reception streams including a grade of a transmission stream to be received from each transmitting client device based on the bitrate map and a summed bitrate that is the sum of the bitrates of each transmission stream grade; and an operation (c) in which the receiving client device selects a combination of reception streams based on frame delay time, wherein, in the operation (c), the receiving client device determines the frame delay time based on a transmission start time information inserted into the media frame received from the transmitting client device and an arrival time of the media frame.

According to the present disclosure, each receiving client device may respond immediately to increased delay time by directly selecting the reception stream from which to receive media based on frame delay time without going through a media server.

In addition, the media server adjusts a bitrate of the transmission stream grade based on a selected combination of streams information of each client device, thereby improving the video quality by allowing each client device to select a transmission stream with a higher bitrate within bandwidth of each client device, reflecting preferences of all client devices.

In addition, because the media server only performs the task of adjusting the bitrate, the amount of computation may be reduced, allowing for faster updates of bitrate adjustments.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating a stream control system according to one embodiment of the present disclosure;

FIG. 2 is an example diagram to explain the operation of a client device;

FIG. 3 is an example of a bitrate map;

FIG. 4 is an example of a selection table;

FIG. 5 is a block diagram schematically showing the configuration of a client device;

FIG. 6 is an example diagram to explain the operation of a media server; and

FIG. 7 is a flowchart for explaining a stream control method according to an embodiment of the present disclosure.

### DETAILED DESCRIPTION OF THE EMBODIMENTS

Hereinafter, the present disclosure will be described in detail with reference to the attached drawings. However, the present disclosure may be implemented in various different forms and is not limited to the embodiments described herein. In addition, the attached drawings are only intended to facilitate easy understanding of the embodiments disclosed in this specification, and the technical ideas disclosed in this specification are not limited by the attached drawings. In order to clearly explain the present disclosure in the drawings, portions that are not related to the explanation are omitted, and the size, shape, and form of each component shown in the drawings may be variously modified. Identical/similar portions throughout the specification are given identical/similar drawing symbols.

The suffixes “module” and “portion” used in the following description for components are given or used interchangeably only for the convenience of writing the specification, and do not have distinct meanings or roles in themselves. In addition, in describing the embodiments disclosed in this specification, when it is determined that a detailed description of a related known technology may obscure the gist of the embodiments disclosed in this specification, the detailed description is omitted.

Throughout the specification, when a portion is said to be “connected (connected, contacted or coupled)” with another portion, this includes not only cases where it is “directly connected (connected, contacted or coupled)”, but also cases where it is “indirectly connected (connected, contacted or coupled)” to the therebetween with another portion in between. In addition, when a portion is said to “include (have or provide)” a certain component, this does not mean that it excludes other components, but rather that it may “include (have or provide)” other components, unless otherwise specifically stated.

The terms indicating ordinal numbers, such as first, second, etc., used in this specification are used only for the purpose of distinguishing one component from another, and do not limit the order or relationship of the components. For example, the first component of the present disclosure may be named the second component, and similarly, the second component may also be named the first component.

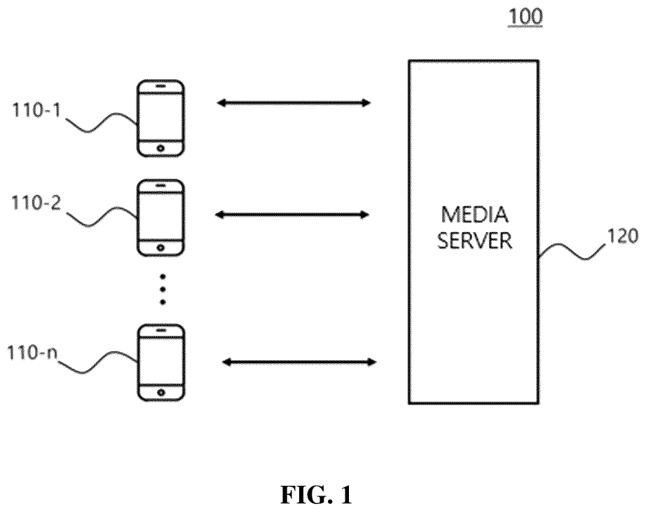

FIG. 1 is a conceptual diagram schematically illustrating a stream control system according to one embodiment of the present disclosure. Referring to FIG. 1, a stream control system 100 according to one embodiment of the present disclosure is described. The stream control system 100 includes a plurality of client devices 110 and a media server 120, and controls transmission streams and reception streams in a many-to-many streaming service in which the plurality of client devices 110 transmit and receive media to each other through the media server 120. Each client device 110 selects a reception stream based on frame delay time and bandwidth, and the media server 120 controls the bit rate of the transmission stream grade of each client device 110 based on the reception stream selected by each client device 110 and the bandwidth of each client device 110 receiving.

Here, each client device 110 performs both the operations of a transmitting client device, which encodes its own media and transmits the encoded media to the media server 120, and the client device 110 receiving, which receives media of another client device 110 from the media server 120.

Next, the client device 110 and the media server 120 are described in detail.

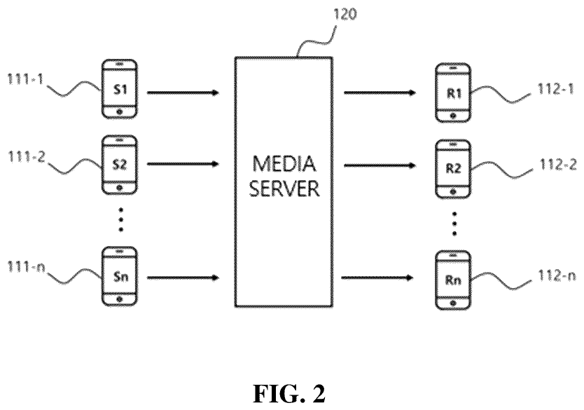

The client device 110 is described with reference to FIG. 2.

A transmitting client device 111 encodes media into multiple transmission stream classes and transmits the encoded media the media server 120. A receiving client device 112 receives from a media server 120 a bitrate map including identification information for each of at least one transmitting client device 111, grade information for a transmission stream transmitted by each transmitting client device 111, and bitrate information for each transmission stream grade. Then, a selection table is generated consisting of combinations of a plurality of reception streams including a grade of a transmission stream to be received from each transmitting client device 111 based on the bitrate map, and a summed bitrate that is the sum of the bitrates of each transmission stream grade, and a combination of reception streams is selected based on the frame delay time.

Here, a first transmitting client device 111-1 is the same device as a first receiving client device 112-1, and the media of the first transmitting client device 111-1 is received by the receiving client device 112 excluding the first receiving client 112-1.

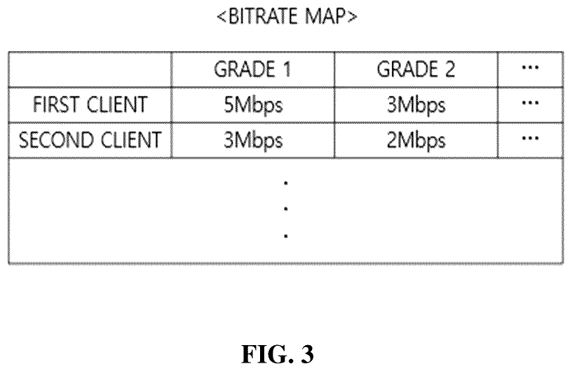

The bitrate map includes identification information of each transmitting client 111, the transmission stream grade transmitted by each transmitting client 111, and bitrate information of each transmission stream grade, as shown in FIG. 3. Each grade may be set to a different bit rate depending on the bandwidth of each transmitting client device 111. The receiving client device 112 generates the selection table based on the bitrate map.

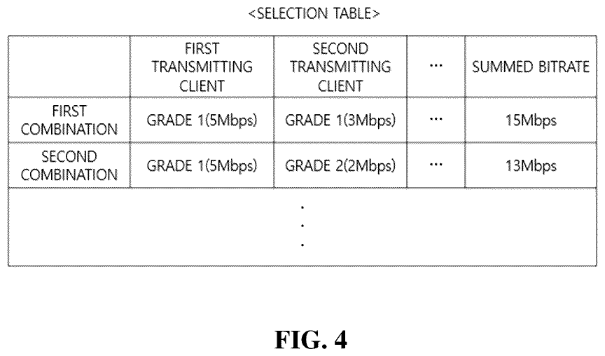

The selection table generated based on the bitrate map is composed of combinations of a plurality of reception streams, as shown in FIG. 4. The combination of the reception streams includes the grade of transmission stream to be received from each transmitting client device 111 and a summed bitrate that is the sum of the bitrates of all transmission stream grades.

In the case of a many-to-many streaming service for n (n is a natural number greater than 2) client devices 110 as in FIG. 2, each receiving client device 112 receives media from n−1 transmitting client devices 111 excluding itself. When the receiving client device 112 receives media from n−1 transmitting client devices 111, and each transmitting client device 111 encodes the media for three grades, 3ⁿ⁻¹ combinations of reception streams may be generated.

Additionally, when m (m is a natural number greater than 2) transmitting client devices 111 transmit media by transmitting client devices 111 that do not transmit media among n−1 transmitting client devices 111, 3^{m} combinations of reception streams may be generated. That is, the combination of reception streams is generated only for the transmitting client device 111 that transmits the media.

The receiving client device 112 selects one of the combination of reception streams and receives the media of each transmitting client device 111. For example, when the first combination of reception streams is selected, the media for the first transmitting client device 111-1 is received at grade 1 and the media for the second transmitting client device 111-2 is received at the grade 1.

In addition, the media frame received by the receiving client device 112 includes transmission start time information inserted by the transmitting client device 111, and the receiving client device 112 determines the frame delay time based on the start time information included in the media frame and an arrival time of the media frame. The receiving client device 112 may measure the delay time for each media frame or at predetermined intervals.

The receiving client device 112 initially selects a combination of reception streams with the lowest summed bitrate among the multiple reception streams included in the selection table and starts streaming. Thereafter, the receiving client device 112 maintains or changes the combination of received streams depending on whether the frame delay time exceeds a preset reference time.

The receiving client device 112 changes to a combination of reception streams combination with a lower summed bitrate when the frame delay time exceeds the reference time, and when the frame delay time is less than the reference time, the receiving client device 112 changes to a combination of reception streams combination with a higher summed bitrate.

Additionally, the receiving client device 112 may sort combinations of received streams having the same summed bitrate based on a quality of experience (QoE) metric. This allows selecting one of the combinations of reception streams with the same summed bitrate based on QoE metric.

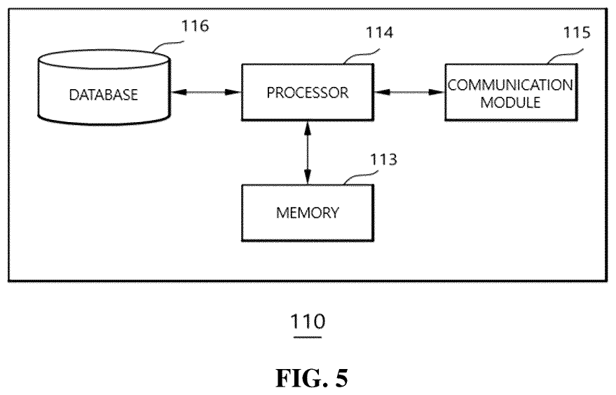

Referring to FIG. 5, the client device 110 is configured to perform operations of the transmitting client device 111 and the receiving client device 112, and includes a memory 113 and a processor 114.

The memory 113 stores the stream control program. The memory 113 may be interpreted as a general term for a nonvolatile storage device that maintains stored information even when power is not supplied and a volatile storage device that requires power to maintain stored information. The memory 113 may temporarily or permanently store data processed by the processor 114. The memory 113 may include magnetic storage media or flash storage media in addition to volatile storage devices that require power to maintain stored information, but the scope of the present disclosure is not limited thereto.

Then, the processor 114 executes a stream control program in the memory 113 to encode and transmit media to the media server 120, and receives a bitrate map for another client device 110 from the media server 120 to select a combination of reception streams to stream media of the other client device 110.

Meanwhile, the processor 114 may perform hardware control functions such as file system, memory allocation, network, basic library, timer, device control (display, media, input device, 3D, etc.), and other utilities required when executing a program. In this embodiment, the processor 114 may be implemented in the form of a microprocessor, a central processing unit (CPU), a processor core, a multiprocessor, an application-specific integrated circuit (ASIC), a field programmable gate array (FPGA), etc., but the scope of the present disclosure is not limited thereto.

The communication module 115 may include a device including hardware and software necessary to perform data communication with an external device and to transmit and receive signals such as control signals or data signals through wired or wireless connections with other network devices. The database 116 may store various operation data for the stream control program to operate. For example, the bitrate map received from the media server 120 and the selection table generated based on the bitrate map may be stored.

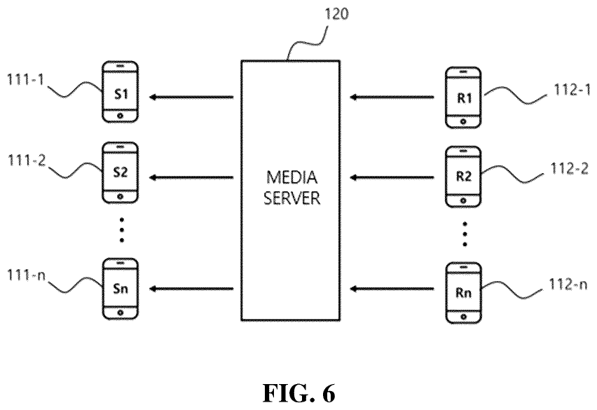

Next, the media server 120 is described with reference to FIGS. 2 and 6.

Referring to FIG. 2, the media server 120 receives encoded media from each transmitting client device 111 during the operation process of the client device 110 described above, and transmits media of the corresponding transmission stream grade to the receiving client device 112 based on the combination of reception streams selected by the receiving client device 112.

In addition, the media server 120 generates a bitrate map to be transmitted to the receiving client device 112. The media server 120 receives bandwidth from each client device 110 and sets a bitrate for each transmission stream grade of the transmitting client device 111 through the bandwidth reception to generate the bitrate map.

For example, a case is described where a media server 120 is connected to three client devices 110, the bandwidth of the first client device is set to 1˜3 Mbps, the bandwidth of the second client device is set to 2˜5 Mbps, and the bandwidth of the third client device is set to 2˜6 Mbps, and each transmitting client device 111 transmits media in three transmission stream grades: high, medium, and low.

Here, the minimum bandwidth range for all client devices 110 is 1 Mbps, the maximum bandwidth range for all client devices 110 is 6 Mbps, and each receiving client device receives two streams, N−1 in number.

The media server 120 may generate a bitrate map by setting the high stream of each transmitting client device 111 to MAX/(N−1)=6/2=3 Mbps, the low stream to MIN/(N−1)=1/2=0.5 Mbps, and the medium stream to 1.75 Mbps, which is the middle value between the high and low streams, to satisfy the maximum and minimum ranges for the bandwidth of all client devices 110.

The media server 120 may perform this operation at the beginning of a many-to-many streaming service, thereby ensuring that all client devices 110 have a selectable combination of reception streams within their bandwidth range.

In addition, referring to FIG. 6, the media server 120 receives a combination of reception streams selected by each receiving client device 112 from each receiving client device 112, and adjusts the bitrate for multiple transmission stream grades of each transmitting client device 111 based on the selected combination of reception streams.

In detail, the media server 120 calculates the utility value of each transmission stream class of each transmitting client device 111 based on the stream retention time of each transmitting client device 111 included in the combination of reception streams selected by each receiving client device 112, and adjusts the bit rate of each transmission stream grade based on the utility value.

For example, the operation of the media server 120 adjusting the bitrate of each transmission stream grade of the first transmitting client device based on the selected reception stream combination of the second receiving client device is described. When the first transmitting client device encodes media into three transmission streams of high, medium, and low levels, and the second receiving client device selects the medium transmission stream of the first transmitting client device and receives the media for 0.5 seconds, the utility value for the medium transmission stream increases by 0.5, and the utility values for the low transmission stream and the high transmission stream decrease by 0.5.

This operation is performed through a combination of selected receive streams received from all receiving client devices, a utility value for each transmission stream grade of the first transmitting client device is calculated for all receiving client devices, and the bitrate for each transmission stream class is adjusted based on the utility value. For example, when the medium transmission stream of the first transmitting client device has higher utility than the high and low transmission streams of the first transmitting client device, the media server 120 increases the bitrate of the medium stream and decreases the bitrate of the high and low streams.

Through this operation of the media server 120, the bit rate of the transmission stream class that is used more by the receiving client device 112 may be increased, thereby improving the reception efficiency of all receiving client device 112.

Additionally, the media server 120 may calculate an increased utility value using Equation 1 and a decreased utility value using Equation 2.

$${\hat{μ}}_{s}^{i} = {\sum }_{j} {p}_{s}^{i , j} ( {r}_{s} + Δ ) \qquad [ Equation 1 ]$$

$${\check{μ}}_{s}^{i} = {\sum }_{j} {p}_{s}^{i , j} ( {r}_{s} - Δ ) \qquad [ Equation 2 ]$$

Equation 1 is an equation that calculates the utility when the receiving client device j increases the bitrate rₛ of the transmission stream of the s-grade of the transmitting client device i by Δ, and Equation 2 is an equation that calculates the utility when the bitrate rₛ is decreased by Δ. Here, pₛ^{i,j} is the time that the receiving client device maintains the transmission stream of grade s of the jth transmitting client device i.

The media server 120 may receive a combination of selected reception streams from each receiving client device 112 at set intervals, or when the receiving client 112 changes the combination of reception streams, the media server 120 may receive the changed combination of reception streams. The media server 120 updates the bitrate map by adjusting the bitrate of the transmission stream grade of each transmission client device 111 and transmits the updated bitrate map to each receiving client device 112.

Each receiving client device 112 may update a plurality of combinations of reception stream included in the selection table through the updated bitrate map, and maintain or change the combinations of reception streams.

Then, the media server 120 repeats the operation of adjusting the bitrate of the transmission stream grade of each transmission client device 111 based on the change in the combination of the reception streams.

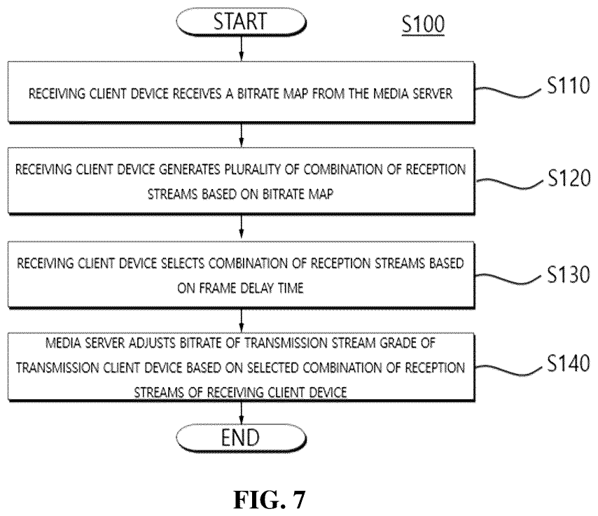

FIG. 7 is a flowchart for explaining a stream control method according to an embodiment of the present disclosure. A stream control method S100 of a many-to-many streaming service according to an embodiment of the present disclosure is described with reference to FIGS. 2, 6, and 7.

Referring to FIG. 2, in operation S110, the receiving client device 112 receives, from the media server 120, a bitrate map including identification information for each of at least one transmitting client device 111, grade information of a transmission stream transmitted by each transmitting client device, and bitrate information for each transmission stream grade.

Thereafter, in operation S120, the receiving client device 112 generates a selection table consisting of a plurality of combination of reception streams including a grade of a transmission stream to receive media from each transmitting client device 111 based on the bitrate map and a summed bitrate that adds up the bitrates of each transmission stream grade, and in operation S130, the receiving client device 112 selects a combination of reception streams based on a frame delay time.

And, referring to FIG. 6, in operation S140, the media server 120 receives information about the combination of reception streams selected from each receiving client device 112, and adjusts the bitrate of at least one transmission stream grade of each transmission client device 111 based on the selected combination of reception streams of each receiving client device 112.

In operation S130, the receiving client device 112 determines the frame delay time based on the transmission start time information inserted into the media frame received from the transmitting client device 111 and the arrival time of the media frame.

Next, each operation is described.

In operation S110, the bitrate map is generated by the media server 120 and includes identification information of each transmitting client device 111, a transmission stream grade transmitted by each transmitting client device 111, and bitrate information of each transmission stream grade, as shown in FIG. 3.

Referring to FIGS. 1 and 2, the process of the media server 120 generating the bitrate map is described. The media server 120 receives bandwidth from each client device 110 and, sets a bitrate for each transmission stream grade of the transmitting client device 111 through this to generate the bitrate map.

For example, a case is described where a media server 120 is connected to three client devices 110, the bandwidth of the first client device is set to 1˜3 Mbps, the bandwidth of the second client device is set to 2˜5 Mbps, and the bandwidth of the third client device is set to 2˜6 Mbps, and each transmitting client device 111 transmits media in three transmission stream grades: high, medium, and low.

Here, the minimum bandwidth range for all client devices 110 is 1 Mbps, the maximum bandwidth range for all client devices is 6 Mbps, and each receiving client device receives two streams, N−1 in number. The media server 120 may generate a bitrate map by setting the high stream of each transmitting client device 111 to MAX/(N−1)=6/2=3 Mbps, the low stream to MIN/(N−1)=1/2=0.5 Mbps, and the medium stream to 1.75 Mbps, which is the middle value between the high and low streams, to satisfy the maximum and minimum ranges for the bandwidth of all client devices 110.

The media server 120 may perform this operation at the beginning of a many-to-many streaming service, thereby allowing all client devices 110 to secure a selectable combination of reception streams within their own bandwidth range.

Next, operation S120, which is a process in which a receiving client device 112 generates the selection table, is described.

The receiving client device 112 generates the selection table based on the bitrate map received from the media server 120. The selection table is composed of a plurality of combinations of reception streams, as shown in FIG. 4. The combination of the reception streams includes the grade of transmission stream to be received from each transmitting client device 111 and a summed bitrate that is the sum of the bitrates of all transmission stream grades. The receiving client device 112 initially selects a combination of reception streams with the lowest summed bitrate among the multiple reception streams included in the selection table and starts streaming.

In the case of the many-to-many streaming service for n (n is a natural number greater than 2) client devices 110 as in FIG. 2, each receiving client device 112 receives media from n−1 transmitting client devices 111 excluding itself. When the receiving client device 112 receives media from n−1 transmitting client devices 111, and each transmitting client device 111 encodes the media for three grades, 3ⁿ⁻¹ combinations of reception streams may be generated.

Additionally, when m (m is a natural number greater than 2) transmitting client devices 111 transmit media by transmitting client devices 111 that do not transmit media among n−1 transmitting client devices 111, 3^{m} combinations of reception streams may be generated. That is, the combination of reception streams is generated only for the transmitting client device 111 that transmits the media.

The receiving client device 112 selects one of the combination of reception streams and receives the media of each transmitting client device 111. For example, when the second combination of reception streams combination is selected, the media for the first transmitting client device 111-1 is received at grade 1, and the media for the second transmitting client device 111-2 is received at grade 2.

Next, operation S130, which is a process in which the receiving client device 112 selects a combination of reception streams based on the frame delay time, is described.

The media frame received by the receiving client device 112 includes transmission start time information inserted by the transmitting client device 111, and the receiving client device 112 determines the frame delay time based on the start time information included in the media frame and an arrival time of the media frame. The receiving client device 112 may measure the delay time for each media frame or at predetermined intervals.

The receiving client device 112 maintains or changes the combination of received streams depending on whether the frame delay time exceeds a preset reference time. The receiving client device 112 changes to a combination of reception streams combination with a lower summed bitrate when the frame delay time exceeds the reference time, and when the frame delay time is less than the reference time, the receiving client device 112 changes to a combination of reception streams combination with a higher summed bitrate.

In addition, operation S140, which is a process in which the media server 120 adjusts the bitrate of the transmission stream class, is described.

The media server 120 receives a combination of reception streams selected by each receiving client device 112 from each receiving client device 112, and adjusts the bitrate for multiple transmission stream grades of each transmitting client device 111 based on the selected combination of reception streams.

In detail, the media server 120 calculates the utility value of each transmission stream class of each transmitting client device 111 based on the stream retention time of each transmitting client device 111 included in the combination of reception streams selected by each receiving client device 112, and adjusts the bit rate of each transmission stream grade based on the utility value.

For example, the operation of the media server 120 adjusting the bitrate of each transmission stream grade of the first transmitting client device based on the selected reception stream combination of the second receiving client device is described. When the first transmitting client device encodes media into three transmission streams of high, medium, and low levels, and the second receiving client device selects the medium transmission stream of the first transmitting client device and receives the media for 0.5 seconds, the utility value for the medium transmission stream increases by 0.5, and the utility values for the low transmission stream and the high transmission stream decrease by 0.5.

This operation is performed through a combination of selected receive streams received from all receiving client devices, a utility value for each transmission stream grade of the first transmitting client device is calculated for all receiving client devices, and the bitrate for each transmission stream class is adjusted based on the utility value.

Through this operation of the media server 120, the bit rate of the transmission stream class that is used more by the receiving client device 112 may be increased, thereby improving the reception efficiency of all receiving client device 112.

The present disclosure may also be implemented in the form of a recording medium including computer-executable instructions, such as program modules executed by a computer. Computer-readable media may be any available media that may be accessed by a computer, and includes both volatile and nonvolatile media, removable and non-removable media. In addition, the computer-readable media may include computer storage media. Computer storage media includes both volatile and nonvolatile, removable and non-removable media implemented in any method or technology for storage of information such as computer-readable instructions, data structures, program modules or other data.

In addition, although the methods and systems of the present disclosure have been described with respect to specific embodiments, some or all of their components or operations may be implemented using a computer system having a general-purpose hardware architecture.

A person having ordinary skill in the art to which the present disclosure pertains understands that the present disclosure may be easily modified into other specific forms without changing the technical idea or essential characteristics of the present disclosure based on the above description. Therefore, it should be understood that the embodiments described above are exemplary in all respects and not limiting. The scope of the present disclosure is indicated by the patent claims described below, and all changes or modifications derived from the meaning and scope of the patent claims and their equivalent concepts should be interpreted as being included in the scope of the present disclosure.

The scope of the present disclosure is indicated by the claims described below rather than the detailed description above, and all changes or modifications derived from the meaning and scope of the claims and their equivalent concepts should be interpreted as being included in the scope of the present disclosure.

What is claimed is:

1. A stream control system for many-to-many streaming services, the stream control system comprising:
a plurality of client devices receiving a bitrate map including identification information for at least one transmitting client device from a media server, grade information of a transmission stream transmitted by each transmitting client device, and bitrate information for each grade of the transmission stream, generating a selection table including a plurality of combinations of reception streams including a grade of a transmission stream to be received from each transmitting client device based on the bitrate map and a summed bitrate that is the sum of the bitrates of each transmission stream grade, and selecting a combination of reception streams based on a frame delay time; and
a media server receiving encoded media from at least one transmitting client device and transmitting the media to at least one receiving client device,
wherein the client device determines the frame delay time based on transmission start time information inserted into a media frame received from the transmitting client device and an arrival time of the media frame.

2. The stream control system of claim 1, wherein
the client device initially selects and streams a combination of reception streams having the lowest summed bitrate among the plurality of combinations of reception streams included in the selection table.

3. The stream control system of claim 1, wherein
the client device measures a delay time of the received media frame and maintains or changes the combination of reception streams depending on whether the delay time exceeds a preset reference time.

4. The stream control system of claim 3, wherein
the client device changes to a combination of received streams having a lower summed bitrate when the delay time exceeds the reference time.

5. The stream control system of claim 3, wherein
the client device changes to a combination of reception streams having a higher summed bitrate when the delay time is less than the reference time.

6. The stream control system of claim 1, wherein
the media server receives information about a selected combination of reception streams from each receiving client device and adjusts a bitrate of at least one transmission stream grade of each transmitting client device based on the selected combination of reception streams of each receiving client device.

7. The stream control system of claim 1, wherein
the media server calculates a maximum utility based on a stream retention time of each transmitting client device included in a combination of reception streams selected by each receiving client device and adjusts a bitrate of each transmitting stream grade of the transmitting client device based on the maximum utility.

8. A method of controlling streams in a many-to-many streaming service, the method comprising:
an operation (a) in which a receiving client device receives, from a media server, a bitrate map including identification information for each of at least one transmitting client device, grade information of a transmission stream transmitted by each transmitting client device, and bitrate information for each transmission stream grade;
an operation (b) in which the receiving client device generates a selection table composed of a plurality of combinations of reception streams including a grade of a transmission stream to be received from each transmitting client device based on the bitrate map and a summed bitrate that is the sum of the bitrates of each transmission stream grade; and
an operation (c) in which the receiving client device selects a combination of reception streams based on frame delay time,
wherein, in the operation (c), the receiving client device determines the frame delay time based on a transmission start time information inserted into the media frame received from the transmitting client device and an arrival time of the media frame.

9. The method of claim 8, wherein
the operation (c) initially selects and streams a combination of reception streams having a lowest summed bitrate among the plurality of combinations of reception streams included in the selection table.

10. The method of claim 8, wherein
the operation (c) measures a delay time of the received media frame and maintains or changes the combination of the reception streams depending on whether the delay time exceeds a preset reference time.

11. The method of claim 10, wherein
the operation (c) changes to a combination of reception streams with a lower summed bitrate when the delay time exceeds the reference time.

12. The method of claim 10, wherein
the operation (c) changes to a combination of reception streams with a higher summed bitrate when the delay time is less than the reference time.

13. The method of claim 8, further comprising:
an operation (d) in which the media server receives information about a combination of reception streams selected from each receiving client device and adjusts a bitrate of at least one transmission stream grade of each transmitting client device based on a selected combination of reception streams of each receiving client device.

14. The method of claim 13, wherein
in the operation (d), the media server calculates a maximum utility based on a stream retention time of each transmitting client device included in the reception stream combination selected by each receiving client device and adjusts a bitrate of each transmitting stream grade of the transmitting client device based on the maximum utility.
